(19) United States
(12) Patent Application Publication
(10) Pub. No.: US 2005/0020698 A1
(43) Pub. Date: Jan. 27, 2005

(54) Reduced VOC two-phase aerosol space spray products

(75) Inventors: George B. Diamond, Glen Gardner, NJ (US); Ralph Helmrich, Glen Gardner, NJ (US); Chung Han Kim, Chungchungnam-Do (KR)

Correspondence Address: OSTROLENK FABER GERB & SOFFEN, 1180 AVENUE OF THE AMERICAS, NEW YORK, NY, 100368403, US

(73) Assignee: George B. Diamond

(21) Appl. No.: 10/867,365

(22) Filed: Jun. 14, 2004

Related U.S. Application Data
(60) Provisional application No. 60/483,673, filed on Jun. 30, 2003.

(51) Int. Cl. B01F 3/04; C09K 3/30; B65D 83/14

(52) U.S. Cl. 516/8.1; 222/635

(57) ABSTRACT

To use significantly less propellant in the manufacture of two-phase aerosol space spray products while avoiding the use of a vapor tap valve the sprayed product uses a reduced concentration of propellant and perhaps also organic solvent, of 8.5-18% by weight. Substantial economic, environmental and consumer safety benefits are also achieved.

### CROSS REFERENCE TO RELATED APPLICATION

This is a continuation of U.S. Provisional Patent Application Ser. No. 60/483,673, filed Jun. 30, 2003 in the name of Chung Han Kim and entitled REDUCED VOC 2 PHASE AEROSOL PRODUCTS.

### BACKGROUND OF THE INVENTION

Many water based aerosol space sprays are made with hydrocarbon propellants. These propellants are not miscible with water and float on top of the aqueous layer. These aerosol space sprays are commonly referred to as two-phase aerosol systems. Emulsifiers (surfactants) are usually used in these systems. Shaking the can forms a short-lived emulsion.

Aqueous two-phase emulsions are more difficult to atomize than most homogenous (single-phase) systems commonly used in aerosols. For this reason two-phase systems require a vapor tap valve to provide an acceptable level of atomization. Propellant vapors are drawn through the vapor tap orifice in the valve body and are mixed with the liquid in the valve and button to produce a finely atomized spray. When needed, a mechanical break-up button may additionally be used to provide even finer atomization.

Since much of the propellant is expelled from the can as vapor through the vapor tap to produce atomization, a relatively large amount of propellant must be provided in the can. For this reason, 25-30% of the can contents by weight of propellant is needed. That amount provides acceptable atomization in most conventional two-phase aerosol systems.

Two-Phase room air fresheners are examples of such a system. The Volatile Organic Compound (VOC) content, including propellant and possibly small amounts of organic solvents, is limited by law to 30% of net weight in many states and has been further limited to 25% in California. These limitations are mandated for environmental reasons since many VOCs, which include hydrocarbons, contribute to the formation of ground level ozone (smog). Initially, CARB (California Air Resources Board) had stipulated a reduction to 20% VOC. Suppliers in the aerosol industry strongly objected stating that such a reduction would not be feasible and would result in an unworkable or inferior product or, as stated by a major manufacturer, “elimination of a product form”. The CSMA (Chemical Specialties Manufacturers Association, an industry association representing the aerosol industry) stated in CARB hearings that reformulation of air fresheners to the 20% VOC level would require the use of excessively high levels of surfactant which “would lead to a sticky spray with fatty odors and surfactant fallout that may damage household surfaces.” As a compromise, 25% VOC was chosen as the new limit.

The common practice in the aerosol industry has been to use the maximum permitted amount of VOCs (either all hydrocarbons or a small amount of alcohol or other solvent with the balance being hydrocarbons) and a vapor tap valve to produce the desired spray pattern and atomization. To produce an acceptably atomized spray without undesirable foaming in the spray, a “water in oil” emulsion is usually formed. While this practice results in reasonably acceptable product performance, these commercial products have certain performance faults:

1. The spray pattern changes during the average usage period. The inventors found by observation of the system in a transparent test vessel that the emulsion begins to break down rather quickly with the hydrocarbon propellant separating and floating to the top. The inventors discovered changes in the emulsion of a number of commercial products beginning in as little as 3-5 seconds after vigorous shaking. This means that in order to ensure uniform product performance, the product must be shaken frequently during use to reestablish the proper emulsion and maintain the desired spray quality.

2. The rate of product expulsion continuously decreases over the usage life of the can. This is due to continued loss of propellant vapors through the vapor tap during usage. These losses cause continuous changes in the propellant/product ratio as well as the propellant composition resulting in a decrease in propellant pressure as the contents are expelled. The inventors have observed decreases in the spray rate of 30% or more. Changes in the propellant/product ratio also cause changes to the characteristics of the emulsion. This produces variation in the spray characteristics over the usage life of the can. The inventors have also observed considerable degradation of spray quality over the life of the can.

### SUMMARY OF THE INVENTION

These observations have led the inventors to the conclusion that, contrary to the conventional practice of using a vapor tap at the valve (and thereby expelling a large excess of propellant), to produce the desired atomization and other spray characteristics, the inventors could produce acceptable (and frequently improved) aerosol products by eliminating the vapor tap and by forming a much more stable (and long lasting) emulsion using a significantly lower ratio of propellant to product. Analysis of the inventors' observations led them to the conclusion that high levels or ratios of propellant to product may actually be detrimental to product performance in that the emulsion begins to separate in a relatively short period of time and therefore the can must be frequently shaken to reestablish the proper emulsion.

The inventors then conducted a series of experiments seeking to form more stable emulsions by tailoring the surfactant system to the other ingredients in the formulation, while using decreasing percentages by weight of propellant and by eliminating the vapor tap from the valve. As the prior experiments had led the inventors to believe, the quality and stability of the emulsion and resulting spray performance actually improved at the lower ratios of propellant to water based product. The new experiments show that workable two-phase air fresheners with acceptable spray patterns and good atomization can be made with 8½% to 18% by weight of hydrocarbon propellant. Should even finer levels of atomization be required, a mechanical break up button can be used to provide enhanced atomization.

This technology can also be used with other water based aerosol products that require good atomization, including flying insect insecticides and room fogger insecticides, and air sanitizers. In the case of water-based formulations that contain solvents other than hydrocarbon propellants, the emulsifier type and level may need to be adjusted to form the proper emulsion. Herein, the functional ingredients are those providing the scent, or the insecticidal or germicidal or other functions of the spray.

The “excess amount” of propellant used in conventional (25-30% propellant by weight) two-phase aerosol products causes a number of problems:

1. Adds substantially to the material cost of the product since the propellant is a major contributor to the ingredient cost.

2. Increases the flammability of the product.

3. Increases the risk of a fuel-air explosion if the product is used in a confined space.

4. Increases the explosive effect if the can ruptures due to accident or misuse.

5. Increases the possibility of a fuel-air explosion occurring during a fire.

6. Contributes excessively to global warming and the formation of ground level ozone (smog).

Based on the extensive use of air fresheners and other two-phase aerosol products in the US and world-wide, the use of the reduced VOC technology disclosed here could result in substantial economic savings and reductions in air pollution emissions.

### BRIEF DESCRIPTION OF THE DRAWING

FIG. 1 shows an example of an aerosol spray can.

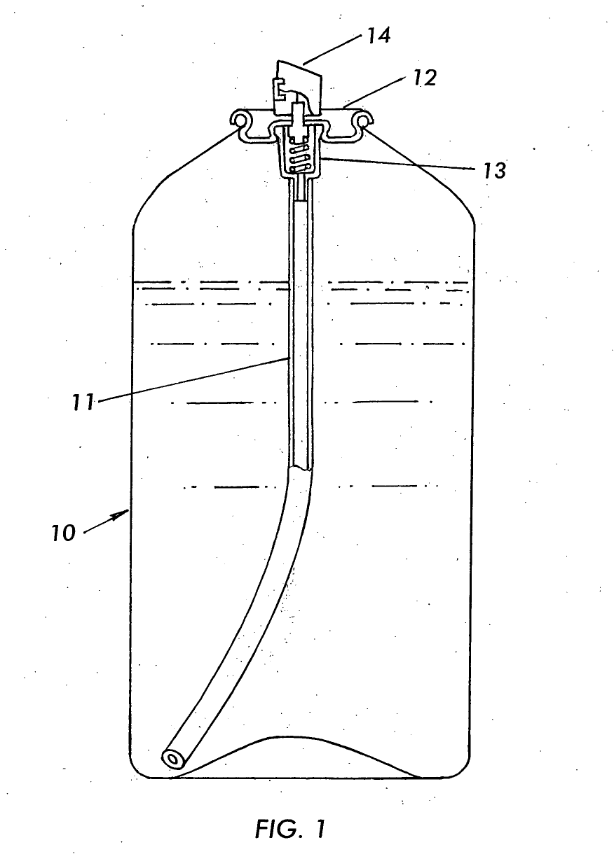

### DESCRIPTION OF THE PREFERRED EMBODIMENTS

The invention is practiced, for example, in a metal, aerosol spray can 10, sealed with a standard aerosol valve 12 at its closed top, a valve body 13 and a mechanical break up button 14 located at the valve. A dip tube 11 draws out the can contents through its inlet at the bottom of the can. The valve is operated in the usual manner by pressing the spray button. There is no vapor tap in the valve.

All the ingredients of the product to be sprayed, except the propellant, are blended together and are filled into the can 10. The can is then sealed and the valve 12 is crimped into place. Hydrocarbon propellant is charged into the can either during the crimping operation (under-the-cap filling) or through the valve after crimping (pressure filling). An emulsion is formed in the can between the water based product and the hydrocarbon propellant upon shaking of the can.

The following are examples of formulations for three embodiments of an aerosol spray:

### EXAMPLE 1

| | |
|---|---|
| Water | 88.99% |
| Corrosion inhibitors | 0.13% |
| Perfume oil | 0.40% |
| Surfactant(s) | 0.48% |
| Hydrocarbon Propellant | 10.00% |

### EXAMPLE 2

| | |
|---|---|
| Water | 87.90% |
| Corrosion inhibitors | 0.13% |
| Perfume oil | 0.40% |
| Surfactant(s) | 0.80% |
| Isopropyl Alcohol | 0.77% |
| Hydrocarbon Propellant | 10.00% |

### EXAMPLE 3

| | |
|---|---|
| Water | 79.97% |
| Corrosion inhibitors | 0.13% |
| Perfume oil | 0.40% |
| Surfactant(s) | 1.50% |
| Hydrocarbon Propellant | 18.00% |

Other formulations may be created by one skilled in the art, using the invention disclosed herein.

An experiment conducted by the inventors is described:

Two transparent aerosol containers were filled by standard aerosol filling methods. One container (Container A) was filled with a conventional, commercially available, nationally marketed, two-phase air freshener product with a propellant weight content of 25%. The other container (Container B) was filled with the air freshener product described in Example 1 with a propellant of weight content of 10%. Prior to shaking of both containers, the aqueous phase in each container settled at the bottom while the propellant phase floated on the top. There was a sharp, visible dividing line between the two layers in both containers. Both containers were then shaken vigorously and placed on a stationary surface and observed while standing.

In Container A (conventional product, 25% propellant), after five seconds had elapsed, separation between the propellant and aqueous phase could be observed. As more time passed, a visible separation line moved down through the liquid, as more of the propellant separated and rose. After approximately 2½ minutes, the separation was substantially complete.

In Container B (the product of Example 1, 10% propellant), the shaken contents remained emulsified for much longer, and after ten seconds, no separation could be observed. Slight separation at the top of the contents of the container was barely perceivable with the aid of a magnifying glass after about 10 minutes. Complete separation in Container B, i.e. the separation of the contents and propellant (as observed before the vigorous shaking), did not occur during the 24 hour observation period. The experimental results show an important benefit of the invention. In standard two-phase aerosol sprays, in order to achieve a good, fine spray, the user must vigorously shake the aerosol spray can at frequent intervals. In the absence of this shaking the nature of the spray degrades from the initial finely atomized spray (where the propellant is thoroughly mixed with the aqueous phase) to a poorly atomized spray or even to a stream, as the propellant has moved up, away from the entrance to the dip tube leading to the valve. While initially, a good mixture (emulsion) with the proper propellant concentration enters the dip tube and flows through the valve, gradually a mixture with more liquid and less propellant enters. With the invention, in contrast, because the emulsion remains unseparated for, such a long time, frequent vigorous shaking is not required at all and such shaking may not be required for several hours in order to maintain a mixture (emulsion) with a proper propellant concentration and therefor a good quality fine spray.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

1. A two-phase, water based, aerosol space spray comprising between 8.5 and 18% hydrocarbon propellant and, this along with water, functional ingredients and emulsifiers.

2. The spray of claim 1, further containing perfume oil.

3. The spray of claim 1, further containing an organic solvent.

4. The spray of claim 1, wherein the dispensed product is an air freshener.

5. The spray of claim 1, wherein the dispensed product is an air sterilizer.

6. The spray of claim 1, wherein the dispensed product is a flying insect insecticide.

7. The spray of claim 1, wherein the dispensed product is a room fogger insecticide.

8. The spray of claim 3, wherein the dispensed product is an air freshener.

9. The spray of claim 3, wherein the dispensed product is an air sterilizer.

10. The spray of claim 3, wherein the dispensed product is a flying insect insecticide.

11. The spray of claim 3, wherein the dispensed product is a room fogger insecticide.

12. A two-phase, water based aerosol space spray comprising between 8.5 and 18% hydrocarbon propellant, an organic solvent, and these along with water, functional ingredients, and emulsifiers.

13. The spray of claim 12, wherein the functional ingredients include perfume oil.

14. A system for dispensing a product in an aerosol spray, comprising:
a sealed can for the spray, a valve on the can operable for dispensing a spray from contents in the can and the contents in the can being comprised of the aerosol space spray of claim 1.

15. The system of claim 14, wherein the valve in the can is without a vapor tap.

16. The system of claim 15, further comprising a mechanical break up button for the spray and located at the valve.
